(19) United States
(12) Patent Application Publication
(10) Pub. No.: US 2005/0045088 A1
(43) Pub. Date: Mar. 3, 2005

(54) Signaling Device

(76) Inventor: Walter Martin, Bath, MI (US)

Correspondence Address: FOSTER, SWIFT, COLLINS & SMITH, P.C., 313 SOUTH WASHINGTON SQUARE, LANSING, MI, 48933, US

(21) Appl. No.: 10/604,925

(22) Filed: Aug. 27, 2003

(51) Int. Cl. B64B 1/40

(52) U.S. Cl. 116/210

(57) ABSTRACT

A signaling device includes a balloon element having a substantially flat center portion and an inflatable peripheral edge. The signaling device also includes an inflation valve assembly connected to said peripheral edge and a canister having compressed gas connected to said inflation valve assembly. The gas may be expelled into the peripheral edge to unfold and stretch the balloon element into its desired shape. The inflated peripheral edge also enables the signaling device to float on water.

### BACKGROUND OF INVENTION

1. Field of the Invention

The present invention generally relates to an inflatable signaling device, and specifically to a device configured to signal aerial search parties in emergencies.

2. Discussion of the Prior Art

Signaling devices used to identify the location of a person in need of assistance are known in the art. With the increasing popularity of outdoor sports activities such as camping, hiking, boating, hunting, and the like, there is an increased need for compact and effective signaling devices for use by individuals involved in these activities.

Some existing signaling devices are buoyant and are well suited for water rescue situations, but due to their construction and weight may not be well suited for land use. Other signaling devices are suitable for land rescue, but would not be suited for a water emergency situation primarily due to their inability to float. One problem with existing signaling devices is balancing the effectiveness of the signaling device and the size and weight of the device. For a signaling device to be useful for land sports where the user is limited in what items he can carry, the size and weight become a major factor.

Thus, there is a desire and a need in the art to provide an emergency signaling device that can be used on water as well as land, and that is light weight and relatively compact.

### SUMMARY OF INVENTION

Accordingly, the present invention provides an emergency signaling device to be used on land or water that is simply constructed and therefore light weight and easy to use.

In one embodiment of the present invention a signaling device includes a balloon element having a substantially flat center portion and an inflatable peripheral edge. An inflation valve assembly is connected to the peripheral edge and a canister containing compressed gas is connectable to the inflation valve assembly. The gas is then expelled into the peripheral edge.

Other features of the present invention will become more apparent to persons having ordinary skill in the art to which the present invention pertains from the following description and claims taken in conjunction with the accompanying figures.

### BRIEF DESCRIPTION OF DRAWINGS

The foregoing features, as well as other features, will become apparent with reference to the description and figures below, in which like numerals represent like elements, and in which:

FIG. 1 is a perspective view of one embodiment of the signaling device of the present invention;

FIG. 2 is a perspective view of one embodiment of the signaling device of the present invention;

FIG. 3 is a perspective view of one embodiment of the signaling device of the present invention; and

FIG. 4 is a perspective view of an embodiment of the present invention in an non-deployed state and enclosed in a carrying case.

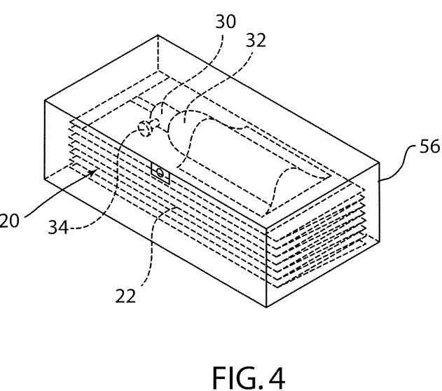

### DETAILED DESCRIPTION

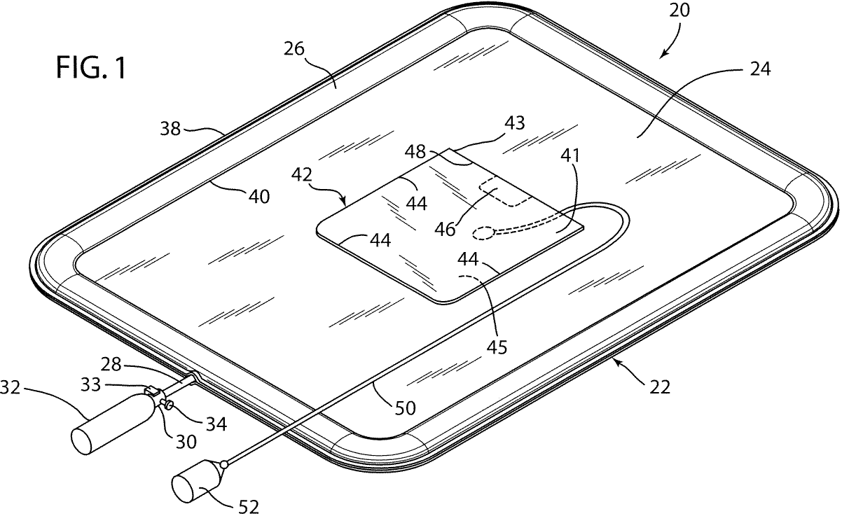

Referring to FIG. 1, the present invention generally relates to a signaling device 20 that can be used on land and water. A signaling device 20 of the present invention may include a balloon element 22 having a substantially flat center portion 24, an inflatable perimeter edge 26, an inflation tube 28 connected to perimeter edge 26. Inflation tube 28 is also connected to an inflation valve assembly 30 known in the art. Inflation valve assembly 30 may include any of a variety of known valve assemblies available in the art configured to be connectable to a canister 32 of a gas such as carbon dioxide (CO₂), and that may allow for only one way expelling of the gas from the canister 32. Valve assembly 30 may include an actuator pin 34 and may optionally include a water pressure switch 33 known in the art. Such switch could be configured to automatically deploy the contents of canister 32 in the presence of a specified water pressure (e.g., if the device is submerged in 2 meters of water). In use, a user could release actuator pin 34 from valve assembly 30 to allow the gas in canister 32 to expel through inflation tube 28 and into perimeter edge 26. Alternatively, or in addition to the actuator pin 34, water pressure switch 33 may be utilized to detect when the signaling device 20 has been submerged in water to a predetermined pressure. Pressure switch 33 would then actuate the canister 32 to inflate balloon element 22 and deploy signaling device 20 automatically.

Balloon element 22 may be constructed of a plastic material and may include two plastic sheets connected together at outer seams 38 by an attachment method such as sonic welding or by stitching so that an air-tight seal is obtained. Inner seams 40 are also included to create inflatable perimeter edge 26. In an alternate embodiment, balloon element 22 could be constructed from one plastic sheet folded to create two plastic sheets connected along one edge. The remaining edges may then be attached along outer seams 36 to create perimeter edge 26. Inner seams 40 may then be applied to create inflatable perimeter edge 26.

Inflatable perimeter edge 26 enables signaling device 20 to be filled with a gas such as CO₂. The gas expelled into perimeter edge 26 enables device 20 to float on water for use in a water related emergency and also aids in forming the shape of signaling device 20. Balloon element 22 may be constructed using a bright colored material such as international orange or red to further enhance the signaling ability. Both the size and color of signaling device 20 of the present invention enable searchers to see signaling device 20 from great distances, which may be needed in an air search rescue.

Balloon element 22 may also include a pocket 42 having a first and second pocket member 41 and 43 that define an interior space 45, on center portion 24. Pocket member 43 may include a portion of center portion 24 with pocket member 41 sonic welded or stitched to pocket member 43 at seams 44. A closure element 46, such as a VELCRO attachment at an edge 48 of pocket 42 may be included to hold pocket 42 in a closed position. An anchor line 50 may also be included and attached within pocket 42. Anchor line 50 may be attached to one of the sheets of plastic defining interior space 45 on one end, and to an anchor 52 on an opposite end. Anchor 52 may be stored within pocket 42 when not in use and used to secure signaling device 20 at a particular location during a water emergency. In addition, anchor 52 may be used to secure signaling device 20 at a particular land location by shortening line 50 and placing anchor 52 on the ground next to signaling device 20. Anchor 52 may be made of lead or other weighted material strong enough to hold signaling device 20 in position on land or sea. Alternatively, anchor 52 could be configured with baffles such as a sea anchor known in the art (not shown).

Balloon element 22 may be folded into a compact condition enabling signaling device 20 to be packed within any suitable pack such as a backpack used by hikers. Alternatively, signaling device 20 may be packed and stored within a carrying case 56, which may also be easily carried within a backpack or other tote. Carrying case 56 provides both convenient storage of signaling device 20 while not in use, and a tote to transport signaling device 20. Carrying case 56 may be designed to contain space for only signaling device 20, or alternatively may be designed to store and transport both signaling device 20 and canister 32. Canister 32 may also be connected to valve assembly 30 while not in use. In addition to storing signaling device 20 and canister 32, anchor 52 may also be stored within carrying case 56. Anchor 52 may be placed and stored within pocket 42 as described previously, or placed loosely within carrying case 56.

To inflate perimeter edge 26, the user may connect inflation valve assembly 30 to canister 32 and then remove actuator pin 34 to allow the gas in canister 32 to expel into perimeter edge 26. Alternatively, if canister 32 has been pre-connected to valve assembly 30, a user simply removes actuator pin 34 to actuate signaling device 20.

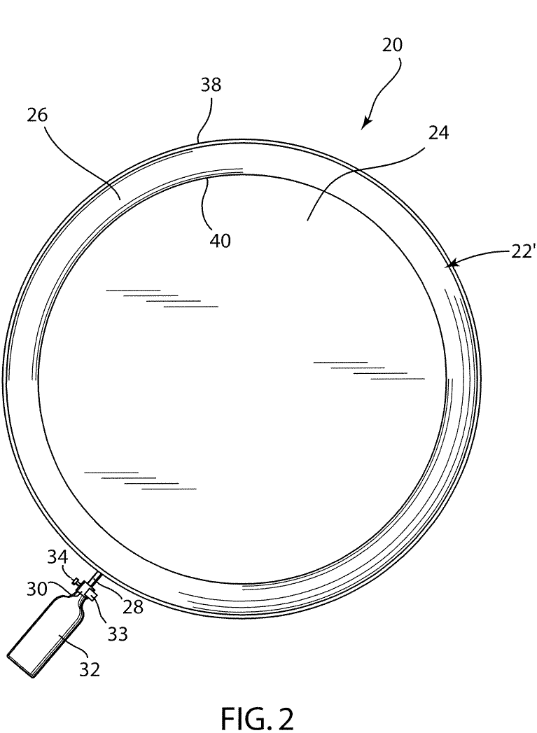

As perimeter edge 26 is inflated, balloon element 22 unfolds and is stretched by the inflated perimeter edge 26 to form the particular shape of balloon element 22. Balloon element 22 in FIG. 1 is substantially square shaped, but could alternatively be any other desired shape such as circular balloon element 22′ shown in FIG. 2.

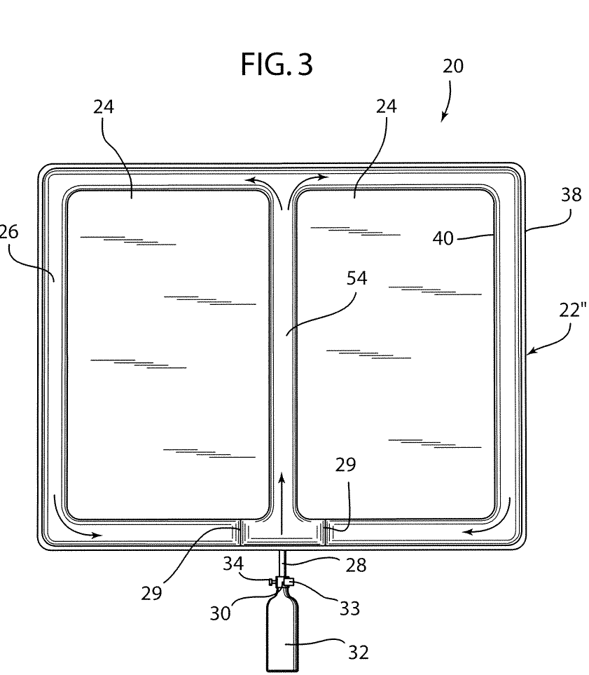

In another alternate embodiment as shown in FIG. 3, balloon element 22″ may include a center inflated portion 54 to further add to the buoyancy of signaling device 20. Center inflated portion 54 may be filled with gas in the same manner as peripheral edge 26. Alternatively, and as shown in FIG. 3, the gas may be directed to pass through center inflated portion 54 first and then around through the peripheral edge 26. A pair of blocking walls 29 may be included near the entry of the gas that prevent gas from flowing into the peripheral edge 26 and instead force the gas to flow into the center inflated portion 54. This configuration allows for deployment to roll-out in an outward direction.

Some of the advantages of the signaling device of the present invention include its simplistic construction and light weight. In addition, signaling device 20 is very versatile due to its compatibility with inflation valves and canisters of compressed gas available in the art, such as those used in inflatable life vests. Signaling device 20 has a unique design, which requires gas to be expelled only into the peripheral edge 26 or to center inflated portion 54. The signaling device 20 of the present invention also provides advantages over prior art signaling devices involving flare guns. Flare guns may accidentally be set off causing harm to a user. Flare guns may also accidentally set fire to trees or other objects when they have been deployed.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

1. A signaling device, comprising:
a balloon element having a substantially flat center portion an inflatable peripheral edge, and an inflatable center channel;
an inflation valve assembly connected to said peripheral edge and center channel;
a canister containing compressed gas connected to said inflation valve assembly; and
wherein said gas is expelled into said peripheral edge upon activation to allow the device to open up to the shape of the signal.

2. (cancelled)

3. (cancelled)

4. A signaling device as defined in claim 1, wherein said center portion includes a first and second member and said first and second member form a pocket capable of holding an object.

5. A signaling device as defined in claim 4, wherein said object includes an anchor connected to an anchor line on one end and said anchor line is connected to one of said first and second members on a second end.

6. A signaling device as defined in claim 4, wherein said pocket further includes a closure element.

7. (cancelled)

8. A signaling device as defined in claim 1, wherein said activation is by release of a pin.

9. A signaling device as defined in claim 1, wherein said activation is by a water pressure switch.

10. A signaling device as defined in claim 1, wherein said device is constructed using a color highly visible from great distances.

11. A signaling device as defined in claim 9, wherein said color is international orange.
